(19) United States
(12) Patent Application Publication
(10) Pub. No.: US 2008/0245877 A1
(43) Pub. Date: Oct. 9, 2008

(54) Electronic Data Storage Medium

(76) Inventors: Pascal Billebaud, Orleans (FR); Yves Reignoux, Clery Saint Andre (FR)

Correspondence Address: THE JANSSON FIRM, 9501 N. CAPITAL OF TX HWY #202, AUSTIN, TX, 78759, US

(21) Appl. No.: 10/432,926

(22) PCT Filed: Nov. 19, 2001
(86) PCT No.: PCT/IB01/02203

§ 371 Date: Aug. 10, 2007

(30) Foreign Application Priority Data
Nov. 28, 2000 (FR) 0015323

(51) Int. Cl. G06K 19/06; B29C 45/14

(52) U.S. Cl. 235/492; 264/261

(57) ABSTRACT

The invention concerns an electronic data storage medium including a body (30) made from insulated plastic material which has two main parallel sides, a semiconductor component (34) and a number of external electrical contact pads flush with the first main side (30a) of the body.

The body (30) includes a recess (32) opening out onto the first main side (30a).

The storage medium also includes a number of conducting elements (28), each with a first end (a) flush with the first main side to form an external contact pad, a second end (b) arranged in the said recess and an intermediate part (c) buried in the body; and

A number of connecting elements (38) to electrically connect the terminals of the semiconductor component to the second ends of the conducting elements.

### FIELD OF THE INVENTION

This invention concerns an electronic data storage medium of the type with a body of insulating material and a semiconductor component fixed in the said body and a mode of realization of such a storage medium.

An electronic data storage medium is considered to be a portable object composed of a body generally made from plastic material in which is fixed a semiconductor component formed by electronic circuits which can store data and generally process it. The semiconductor component is connected electrically to external electrical contact pads to make the electrical link between the semiconductor component and the circuits of a reading and writing device into which the storage medium is inserted.

The reading and writing device is associated with various devices controlled by the reader, these devices may be ticket distributors, payment terminals, fixed telephones or GSM type portable telephones. The term electronic memory cards or bank cards is used for the storage media used in payment terminals or in fixed telephones, these cards having a right parallelepiped body and reduced thickness whose dimensions are defined by standards. For portable telephones, the so-called SIM cards may have various types of body shape adapted to the readers associated with the portable telephones.

This invention concerns the various types of electronic data storage media defined above.

### BACKGROUND OF THE INVENTION

To manufacture these types of electronic data storage media, the technique most often used is as follows:

in a first step, a data storage medium body is created with the required external shape, and including a recess. In a second step, an electronic module is produced, composed of the semiconductor component which is fixed on a support, this support itself defining the external electrical contact pads connected to the semiconductor component. Lastly, the electronic module is fixed in the recess of the body of the electronic data storage medium.

These various steps and in particular the realization of the electronic module are relatively complex and therefore generate relatively high costs, whereas the manufacture of the electronic data storage medium must have a global manufacturing cost as low as possible so that this cost has no significant impact on the service that can be obtained using the electronic data storage medium.

Also, the electronic module is “relatively large” and it is difficult to fix in the recess of the body of the electronic data storage medium.

### SUMMARY OF THE INVENTION

The first objective of this invention is to supply an electronic data storage medium which can be manufactured at a lower cost whilst offering the same quality.

To reach this objective, according to the invention, the electronic data storage medium includes a body made from insulated plastic material which has two main parallel sides, a semiconductor component and a number of external electrical contact pads flush with the first main side of the body. It is characterized in that:
the said body includes a recess opening out onto the first main side, in which the semiconductor component is fixed,
the said storage medium also includes:
   a number of conducting elements, each conducting element having a first end flush with the first main side to form an external contact pad, a second end arranged in the said recess and an intermediate part buried in the body; and
   a number of connecting elements to electrically connect the terminals of the semiconductor component to the second ends of the conducting elements; the volume of the said recess not occupied by the said semiconductor component being filled by an insulating material.

We can see that in the electronic data storage medium defined above, the conducting elements intended to form external electrical contact pads and some of the electrical connecting assembly between the semiconductor component and the external contact pads are partly buried in the plastic body of the data storage medium, thereby fastening them and positioning them with respect to the body of the data storage medium, this body including a recess in which the semiconductor component alone can be easily fixed. After fitting the electrical connecting elements, the recess is filled with a plastic material such as an epoxy resin to obtain the final shape of the electronic data storage medium.

According to a preferred mode of realization, the electrical data storage device is characterized in that each electrical conducting element has the shape of a blanked part, the two ends of this part being approximately parallel and the intermediate part being inclined and having a non rectilinear shape, the recess being offset with respect to the portion of the main side of the body containing the first ends of the electrical conducting elements which form the external electrical contact pads.

According to this preferred mode of realization, the recess intended to receive the semiconductor component is offset with respect to the location of the external electrical contact pads. It is therefore possible to use a large semiconductor component whilst giving all the external electrical contact pads the configuration which is provided for in particular by the ISO standards concerning bank cards or cards for fixed telephones.

Another objective of this invention is to supply a mode of realization of an electronic data storage medium which reduces the cost of manufacture whilst producing electronic data storage media which have the same characteristics as with the modes of realization of the prior art.

To reach this objective according to the invention, the method of manufacturing an electronic data storage medium including a body, a semiconductor component, external electrical contact pads and electrical connecting elements between the said component and the said external contact pads, is characterized in that it includes the following steps:
a mould is supplied, whose cavity has the shape of the body to be produced, the said cavity having one main side flat, the said mould having a core projecting into the said main side;
in the said cavity a number of electrical conducting elements are arranged, each having a first end applied against the said main side, to form an external contact pad, a second end applied against the said core and an intermediate part;
a hot thermoplastic material is injected under pressure into the said cavity so that the said material fills the entire volume of the cavity not occupied by the said conducting elements;
the part so produced is demoulded, to obtain the body of the data storage medium with a recess, the first ends of the conducting elements being flush with the main side, the second ends of the conducting elements being flush with the wall of the said recess, the intermediate part of the conducting elements being buried in the thermoplastic material;
the said semiconductor component is fixed in the said recess;
the second ends of the conducting elements are connected electrically to the terminals of the semiconductor component; and
the volume of the said recess not occupied by the said semiconductor component is filled with an insulating material.

Other features and advantages of the invention will appear on reading the description which follows of several modes of realization of the invention given as non-limiting examples. The description refers to the attached figures, on which:

### BRIEF DESCRIPTION OF THE DRAWINGS

FIG. 1 is a vertical cross section of an injection mould which can be used to manufacture the data storage medium;

FIGS. 2a to 2c are vertical cross sections of the storage device illustrating the various steps of its manufacture;

FIG. 3 is a partial plan view of a finished data storage medium;

FIG. 4 is a plan view of a first realization variant of the data storage medium;

FIG. 5 is a plan view of a second realization variant of the data storage medium; and

FIG. 6 is a partial vertical cross section of a third realization variant of the data storage medium.

### DETAILED DESCRIPTION

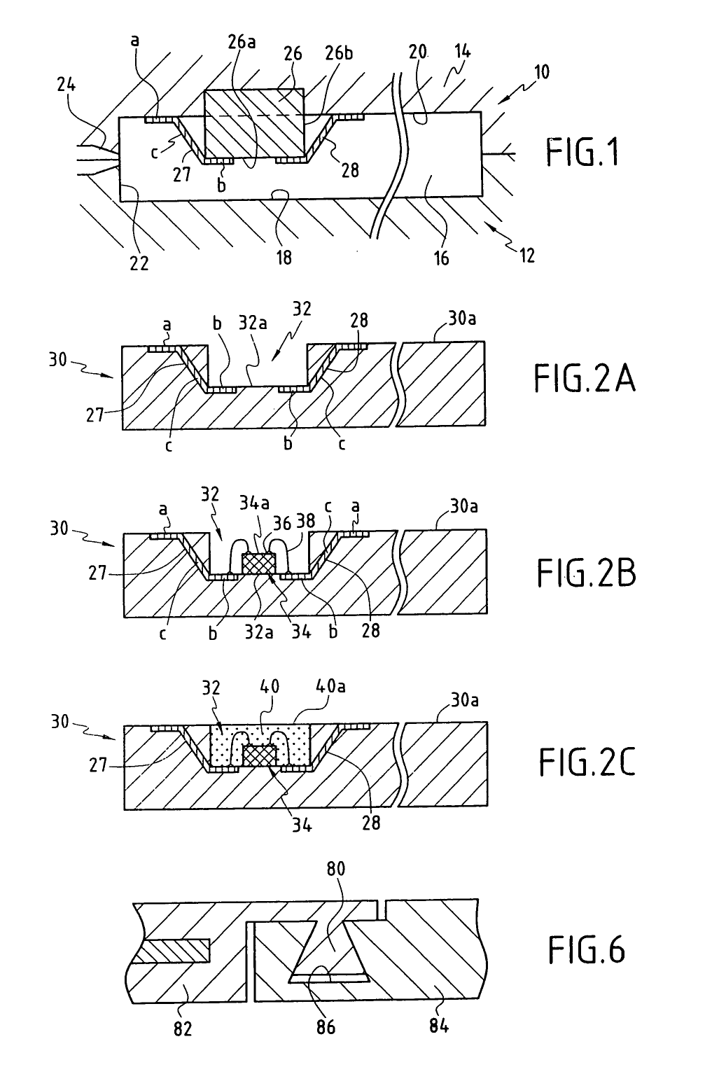

Referring firstly to FIGS. 1 to 3, we will describe a preferred mode of realization of the electronic data storage medium.

FIG. 1 shows a vertical cross section of an injection mould which can be used to manufacture the body of the data storage medium. The mould 10 is formed from a lower fixed part 12 and an upper mobile part 14 which define a hollow or cavity. The cavity 16 has the external shape of the body of the data storage device and has two main flat parallel sides 18 and 20 and an outer edge 22 defined by parts 12 and 14 of the mould. The mould also has a injection nozzle 24 for the plastic material used to make the body of the data storage medium. In the main side 20 of the mould cavity 16 a core 26 is mounted, projecting into the main side 20 to form a recess in the body obtained by moulding.

Before injecting the plastic material through the nozzle 24, conducting elements such as 26 and 27 are positioned, intended to form the external electrical contact pads of the storage medium and part of the connection between the semiconductor components and the external contact pads. In this mode of realization, the conducting elements 26 and 27 include a first end a, a second end b and an intermediate part c which are obtained for example by folding a metal strip. The ends a and b are parallel whereas the intermediate part c is inclined. The mould 10 includes means not represented to press the ends a of the conducting elements 26 and 28 against the main wall 20 of the cavity 16 and means to press the second ends b against the end side 26a of the core 26. These support means can either be vacuum systems or electromagnetic systems. It must be pointed out that the intermediate parts c of the conducting elements 27 and 28 are kept away from the side wall 26b of the core 26. Means are also provided to maintain the positioning of the conducting elements 27 and 28 in the mould cavity.

The thermoplastic material is injected into the mould cavity 16 via the injection nozzle(s) 24. The material is injected hot and under pressure. The injection material can be for example ABS or other similar materials. If ABS is used, the injection temperature lies preferably between 270 and 290° C. whereas the mould and the core are kept at a temperature of preferably between 10 and 50° C.

After solidification of the moulding material, the part so produced is demoulded. It is represented on FIG. 2a. It consists of a moulded part 30 forming the body of the data storage medium which of course has the shape of the mould cavity 16 with the recess 32 formed by the core 26.The conducting elements 27 and 28 are fastened to the body 30 especially due to the fact that their intermediate parts c are buried in the plastic material. However, the first ends of the conducting elements a are flush with the main side 30a of the data storage medium whereas the second ends b are flush with the bottom 32a of the recess.

In the next step represented by FIG. 2b, the semiconductor component 34 is fixed on the bottom 32a of the recess 32 by any suitable means. The semiconductor component includes terminals 36 in its upper side 34a. The electrical connection between the terminals 36 of the semiconductor components and the ends b of the conducting elements 27, 28 are made with soldered conducting wires such as 38.

To carry out this step, the “flip-chip” technique can also be used. This technique consists of making a conducting bump on each terminal of the semiconductor chip. These bumps are fixed directly on the ends b of the conducting elements 28. This avoids the use of conducting wires. We can see that in this case, the side 34a of the semiconductor chip with the terminals 36 is turned towards the bottom 32a of the recess 32. Preferably, a layer of insulating material is first applied on side 34a of the chip between the conducting bumps, this layer having approximately the same thickness as the bumps.

In the last step illustrated by FIG. 2c, the volume of the recess 32 not occupied by the semiconductor component 34 is filled with an insulating plastic material 40 which may, for example, be an epoxy resin. The upper side 40a of this material may possibly be machined on the surface so that this upper side is flush in the upper side 30a of the body of the data storage medium.

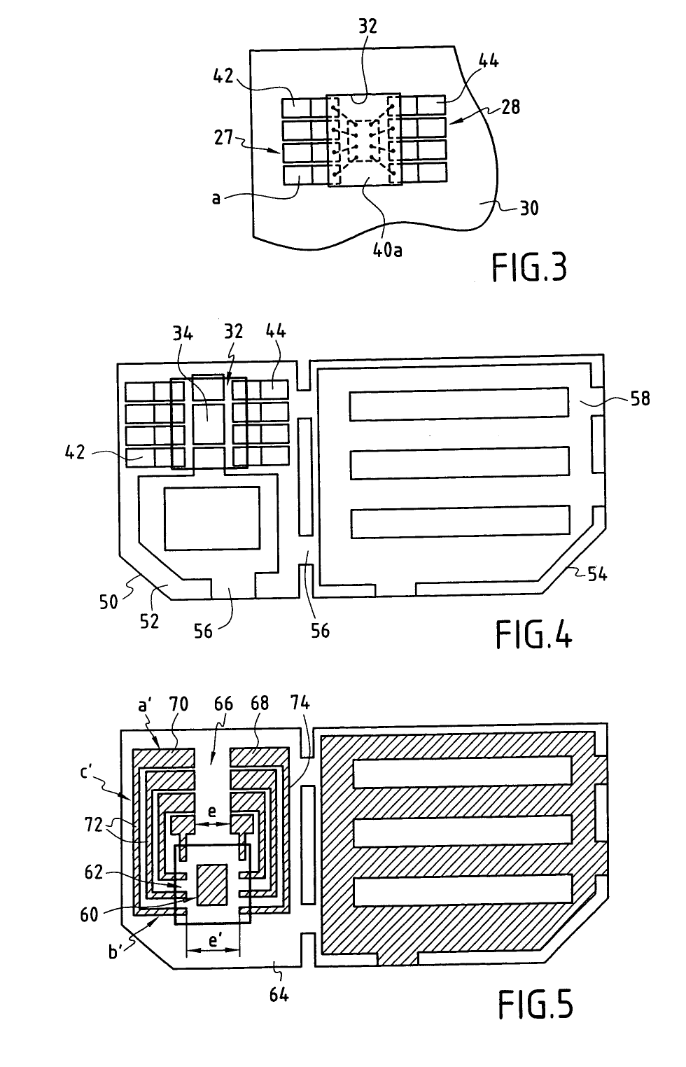

FIG. 3 represents a plan view of part of the body 30 of the data storage medium. This figure shows the ends a of the conducting elements 27 and 28. Preferably, the conducting elements 27 and 28 are arranged in two parallel rows of four conducting elements. These ends a form the external electrical contact pads 42 and 44 of the data storage medium. This figure also shows the upper side 40a of the plastic material filling the recess 32.

FIG. 4 represents a plan view of a realization variant of the electronic data storage medium if this storage medium forms a SIM card of modifiable dimensions. The body of the storage medium 50 which is obtained by moulding, as previously explained, has a first portion 52 which contains the semiconductor component 34 and a second portion 54, these two portions being connected by snap-off areas 56 made from the same plastic material. To provide the mechanical strength of the body of the data storage medium, during the injection moulding, it would be possible to insert metal grids such as 56 and 58 in the mould cavity. The internal sides of the two parts of the mould are preformed to obtain the hollows defining the snap-off areas 56.

Preferably, the card body obtained by moulding has the dimensions of an ISO type card, i.e. rectangular shape with dimensions approximately 8.5 mm×55 mm. From the card so obtained, a card with the shape represented on FIGS. 4 and 5 can be obtained, either by planning, during the moulding, pre blanking slots or by blanking the card body after the moulding step.

In the mode of realization represented on FIG. 4, the external electrical contact pads 42 and 44 are arranged each side of the recess 32 containing the semiconductor component 34. This arrangement is only suitable if the semiconductor component 34 has relatively reduced dimensions so that connecting elements can be fitted between the terminals of the semiconductor component and the external contact pads represented on FIG. 2. This is the configuration which is presently used for bank cards or cards for fixed telephones.

FIG. 5 represents a realization variant allowing the use of a semiconductor component 60 of larger dimensions.

According to this mode of realization, the recess 62 made in the body 64 to take the semiconductor component 60 is offset with respect to the area 66 of the body, flush with the external electrical contact pads 68 and 70. To obtain this offset, the electrical conducting elements 72 and 74 placed in the mould have a special shape. Each conducting element 72 or 74 has a first end a′, a second end b′ and an intermediate part c′. The first and second ends a′ and b′ are identical with the ends a and b of FIG. 2 or 4. However, the intermediate part c′ is blanked from a conducting sheet so as to produce a non rectilinear shape (U shape) to obtain the offset between the recess 62 and the external contact pads 68 and 70 formed by the ends a′ of the conducting elements 72 and 74. We may also consider that the intermediate parts c′ of the conducting elements 72 and 74 are perpendicular to the ends a′ and b′.

With this arrangement, the spacing e between the two rows of external contact pads 68 and 70 provided for by the standards can be respected whilst creating a space e′ between the second ends b′ of the conducting elements which is compatible with the dimensions of the semiconductor components 60.

FIG. 6 shows a third mode of realization of the card body. During the moulding operation, a special shape is planned for the cavity in order to realize a projection 80 of the card body 82 parallel to one edge of the card body. This projection forms a male clipping part, for example, in the shape of a dovetail. The card body 82 can then be fixed on an extension 84 of the card body so that the body of the card so obtained has greater dimensions. The extension 84 includes, for example, a groove 86, also in the shape of a dovetail, to clip mechanically onto the male part 80.

What is claimed is:

1. An electronic data storage medium including a body made from insulated plastic material which has two main parallel sides, a semiconductor component and a number of external electrical contact pads flush with the first main side of the body, wherein,
the said body includes a recess opening out onto the first main side, in which the semiconductor component is fixed,
the said storage medium also includes:
a number of conducting elements, each conducting element having a first end flush with the first main side to form an external contact pad, a second end arranged in the said recess and an intermediate part buried in the body; and
a number of connecting elements to electrically connect the terminals of the semiconductor component to the second ends of the conducting elements; the volume of the said recess not occupied by the said semiconductor component being filled by an insulating material.

2. The electronic data storage medium according to claim 1, wherein each electrical conducting element has the shape of a folded conducting strip, the two ends being approximately parallel and the intermediate part being inclined, the said recess being arranged between the second ends of the conducting elements forming the external contact pads.

3. The electronic data storage medium according to claim 1, wherein each electrical conducting element has the shape of a blanked part, the two ends being approximately parallel and the intermediate part being inclined and having a shape not rectilinear with the said ends, the said recess being offset with respect to the portion of the main side of the body containing the first ends of the electrical conducting elements.

4. The electronic data storage medium according to claim 1, wherein the said body has the shape of a right parallelepiped with two main sides parallel and an edge.

5. The electronic data storage medium according to claim 4, wherein the said body has aligned hollows separating a first body portion containing the said semiconductor component and the said external contact pads, and a second portion, the said hollows enabling the two body portions to be separated.

6. The electronic data storage medium according to claim 4, wherein the said body has near its edge elements to clip onto another part.

7. A method of manufacturing an electronic data storage medium including a body, a semiconductor component, external electrical contact pads and electrical connecting elements between the said component and the said external contact pads, said method comprising:
supplying a mould, whose cavity has the shape of the body to be produced, the said cavity having one main side flat, the said mould having a core projecting into the said main side;
arranging a number of electrical conducting elements in the said cavity, each having a first end applied against the said main side, to form an external contact pad, a second end applied against the said core and an intermediate part;
injecting a hot thermoplastic material under pressure into the said cavity so that the said material fills the entire volume of the cavity not occupied by the said conducting elements;
demoulding the part so produced, to obtain the body of the data storage medium with a recess, the first ends of the conducting elements being flush with the main side, the second ends of the conducting elements being flush with the wall of the said recess, the intermediate part of the conducting elements being buried in the thermoplastic material;
fixing the said semiconductor component in the said recess;
electrically connecting the second ends of the conducting elements to the terminals of the semiconductor component; and
filling the volume of the said recess not occupied by the said semiconductor component with an insulating material.
